(19) United States
(12) Patent Application Publication
(10) Pub. No.: US 2024/0058916 A1
(43) Pub. Date: Feb. 22, 2024

(54) MEASURING DEVICE, AND PROGRAM

(71) Applicant: FANUC CORPORATION, Yamanashi (JP)

(72) Inventor: Kenji KAIHARA, Yamanashi (JP)

(73) Assignee: FANUC CORPORATION, Yamanashi (JP)

(21) Appl. No.: 18/260,200

(22) PCT Filed: Mar. 22, 2022
(86) PCT No.: PCT/JP2022/013297

§ 371 Date: Jun. 30, 2023

(30) Foreign Application Priority Data
Mar. 25, 2021 (JP) 2021-051676

(51) Int. Cl. B23Q 17/22

(52) U.S. Cl. CPC B23Q 17/22

(57) ABSTRACT

Provided is a measuring device capable of flexibly identifying a different tool detection position for each user, for example. This measuring device for measuring a distance from a reference position in a machine tool to a tool detection position of a measuring instrument, for said measuring instrument for measuring the length of a cutting tool mounted in the machine tool, comprises: a speed acquiring unit for acquiring a predetermined feeding speed at which the cutting tool is moved toward the measuring instrument when the length of the cutting tool is being measured; a movement control unit for causing a pressed surface of the measuring instrument to be pressed by a reference tool which has a known length and which is mounted in the machine tool, by moving a tip end of the reference tool toward the measuring instrument at the feeding speed acquired by the speed acquiring unit; a detecting unit for detecting a signal indicating the tool detection position, output as a result of the pressing of the measuring instrument; and an identifying unit for identifying the tool detection position of the measuring instrument on the basis of the position of the tip end of the reference tool at the timing at which the signal was detected.

### TECHNICAL FIELD

The present invention relates to a measuring device and a program.

### BACKGROUND ART

Conventionally, a numerical control device that controls a machine tool or the like executes machining or the like of a workpiece according to a machining program. In such cases, it is desirable to precisely correct the position coordinates of a tool tip to calibrate a mechanical error of a tool (e.g., cutting tool) attached to a machine tool in order to achieve precise machining of a workpiece. Therefore, a device has been proposed to identify the coordinates of a tool tip in actual machining (for example, see Patent Documents 1 and 2).
Patent Document 1: Japanese Unexamined Patent Application, Publication No. H11-138392
Patent Document 2: Japanese Unexamined Patent Application, Publication No. H11-99450

### DISCLOSURE OF THE INVENTION

### Problems to be Solved by the Invention

When the coordinates of a tool tip are identified, for example, a measuring instrument disposed on a table of a machine tool is used. The measuring instrument can detect pressing down of a pressed surface to a tool detection position by the tool tip. The measuring instrument is configured to be able to transmit a detection signal to a numerical control device in response to the pressing down to the tool detection position. The numerical control device measures the tool length of the tool based on the feed position of the tool at the timing of receiving the detection signal.

Incidentally, in measuring the tool length, the feed speed of the tool may be changed based on a user's or other person's request. The output signal from the measuring instrument is output based on mechanical contact between the tool and the measuring instrument. Thus, the tool detection position may vary depending on the feed speed of the tool. Therefore, it is desirable to flexibly identify a different tool detection position for each user or the like.

### Means for Solving the Problems

The present disclosure relates to a measuring device for measuring, with respect to a measuring instrument for measuring a length of a cutting tool attached to a machine tool, a distance from a reference position of the machine tool to a tool detection position of the measuring instrument. The measuring device includes a speed acquisition unit configured to acquire a preset feed speed at which the cutting tool is moved toward the measuring instrument when the length of the cutting tool is measured, a movement control unit configured to move a tip of a standard tool having a known length attached to the machine tool toward the measuring instrument at the feed speed acquired by the speed acquisition unit, thereby causing the standard tool to press down a pressed surface of the measuring instrument, a detection unit configured to detect a signal indicating the tool detection position, output by the pressing down of the measuring instrument, and an identification unit configured to identify the tool detection position of the measuring instrument based on a position of the tip of the standard tool at a timing when the signal is detected.

The present disclosure relates to a program causing a computer to function as a measuring device for measuring, with respect to a measuring instrument for measuring a length of a cutting tool attached to a machine tool, a distance from a reference position of the machine tool to a tool detection position of the measuring instrument. The program causes the computer to function as: a speed acquisition unit configured to acquire a preset feed speed at which the cutting tool is moved toward the measuring instrument when the length of the cutting tool is measured, a movement control unit configured to move a tip of a standard tool having a known length attached to the machine tool toward the measuring instrument at the feed speed acquired by the speed acquisition unit, thereby causing the standard tool to press down a pressed surface of the measuring instrument, a detection unit configured to detect a signal indicating the tool detection position, output by the pressing down of the measuring instrument, and an identification unit configured to identify the tool detection position of the measuring instrument based on a position of the tip of the standard tool at a timing when the signal is detected.

### Effects of the Invention

According to the present disclosure, it is possible to provide a measuring device and a program capable of flexibly identifying a different tool detection position for each user or the like.

### BRIEF DESCRIPTION OF THE DRAWINGS

FIG. 1 shows an outline of a machine tool in a measuring device according to a first embodiment of the present disclosure;

FIG. 2 shows a configuration of the measuring device according to the first embodiment;

FIG. 3 shows a positional relationship between a tool of the machine tool and a measuring instrument in the measuring device of the first embodiment;

FIG. 4 shows a positional relationship between a tool of a machine tool and a measuring instrument in a measuring device according to a second embodiment of the present disclosure; and

FIG. 5 is a flowchart showing an operation flow of the measuring device according to the second embodiment.

### PREFERRED MODE FOR CARRYING OUT THE INVENTION

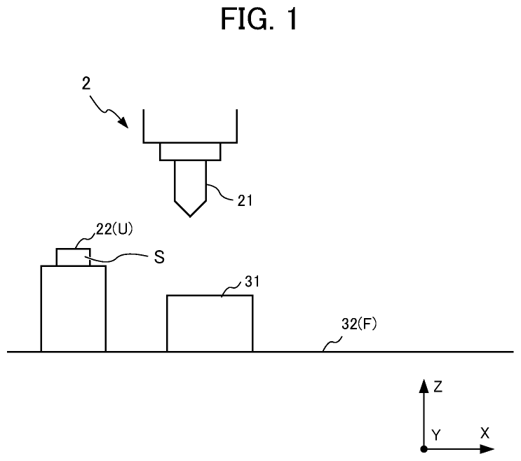

Hereinafter, a measuring device 1 according to each embodiment of the present disclosure will be described with reference to FIGS. 1 to 5. First, before describing the measuring device 1 according to each embodiment, a machine tool 2 connected to the measuring device 1 will be described.

The machine tool 2 can machine a workpiece 31 using a cutting tool 21, for example, as shown in FIG. 1. Specifically, the machine tool 2 can machine the workpiece 31 conveyed on a table 32 using the cutting tool 21. The machine tool 2 machines the workpiece 31 by bringing the tip of the cutting tool 21 attached to a tool holder (not shown) into contact with the workpiece 31. The machine tool 2 includes a measuring instrument 22.

The measuring instrument 22 is used to measure the length (tool length) of the cutting tool 21 attached to the machine tool 2. The measuring instrument 22 is used, for example, to measure the actual length of the cutting tool 21 in which wear or the like occurs due to machining of the workpiece 31. As an example, the measuring instrument 22 is used to measure the actual length of the cutting tool 21 in advance before cutting the workpiece 31. The measuring instrument 22 detects pressing down by the cutting tool 21. The measuring instrument 22 outputs a signal in response to detection of pressing down.

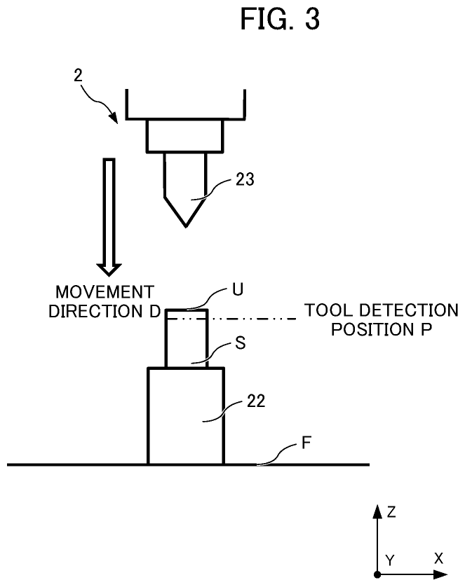

The measuring instrument 22 is disposed, for example, on a top surface (hereinafter, also referred to as a reference position F; the top surface of the table 32 is an example of the reference position F) of the table 32. The measuring instrument 22 has a predetermined height. The measuring instrument 22 includes a switch S pressed down by the tip of the cutting tool 21 or a standard tool 23 (described later), in an upper part including a pressed surface U. Although the pressed surface U is generally an upper surface in a vertical direction, the pressed surface U may face a side other than the vertically upper side, depending on the installation direction of the measuring instrument 22. When the switch S is pressed down to a predetermined position, the measuring instrument 22 outputs a signal indicating that the pressing down is detected at the predetermined position. That is, when the switch S is pressed down to a tool detection position P (see FIG. 3) located at a predetermined distance from the pressed surface U, the measuring instrument 22 outputs a signal indicating the pressing down by the cutting tool 21 or the standard tool 23.

Next, an outline of the measuring device 1 will be described. The measuring device 1 is configured, for example, as a part of a numerical control device. The measuring device 1 controls the operation of the cutting tool 21 with respect to the machine tool 2. Furthermore, the measuring device 1 measures the tool length of the cutting tool 21 by acquiring a signal from the measuring instrument 22.

In the following embodiments, the measuring device 1 identifies the tool detection position P set in the measuring instrument 22 prior to measuring the tool length of the cutting tool 21. For example, the measuring device 1 uses the standard tool 23 having a known length instead of the cutting tool 21 to identify the tool detection position P. In particular, the measuring device 1 identifies the tool detection position P depending on the feed speed of the cutting tool 21 set in advance by the user of the machine tool 2 or the like. The measuring device 1 can measure the distance from the reference position F of the machine tool 2 to the tool detection position P of the measuring instrument 22. Thus, the measuring device 1 optimizes the tool detection position P depending on the feed speed set by the user or the like with respect to the detection of the tool detection position P accompanied by the mechanical operation of the measuring instrument 22. Therefore, the accuracy of measuring the length of the cutting tool 21 can be improved.

### First Embodiment

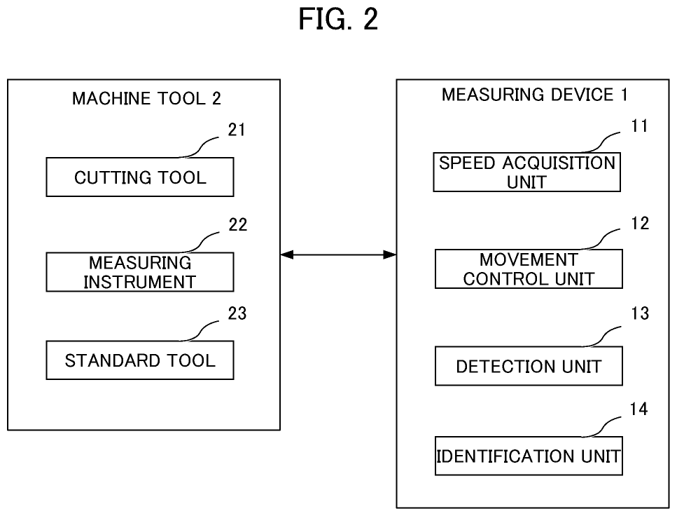

Next, a measuring device 1 and a program according to a first embodiment of the present disclosure will be described with reference to FIGS. 1 to 3. As shown in FIG. 2, the measuring device 1 is configured to be communicable with a machine tool 2. The measuring device 1 includes a speed acquisition unit 11, a movement control unit 12, a detection unit 13, and an identification unit 14.

The speed acquisition unit 11 is implemented, for example, by a CPU operating. The speed acquisition unit 11 acquires a preset feed speed at which a cutting tool 21 is moved toward a measuring instrument 22 when the length of the cutting tool 21 is measured. The speed acquisition unit 11 acquires, for example, a feed speed that is preset when the tool length of the cutting tool 21 is measured, and at which the cutting tool 21 is moved from a position above the measuring instrument 22 toward the measuring instrument 22. The speed acquisition unit 11 acquires the feed speed of the cutting tool 21, for example, by reading the feed speed from a program storage unit (not shown) for storing the feed speed of the cutting tool 21 when the tool length is measured.

The movement control unit 12 is implemented, for example, by the CPU operating. As shown in FIG. 3, the movement control unit 12 moves the tip of a standard tool 23 having a known length attached to the machine tool 2 toward the measuring instrument 22 in the axial direction, for example. The movement control unit 12 moves the standard tool 23 at a feed speed acquired by the speed acquisition unit 11, thereby causing the standard tool 23 to press down the pressed surface of the measuring instrument 22. The movement control unit 12 moves the tip of the standard tool 23 having a known length attached to the machine tool 2 toward a pressed surface U of the measuring instrument 22 in the axial direction (movement direction D), for example. The movement control unit 12 moves the tip of the standard tool 23 toward the tool detection position P of the measuring instrument 22 while pressing and moving the pressed surface U of the measuring instrument 22 with the tip of the standard tool 23 attached to the machine tool 2. The movement control unit 12 moves the tip of the standard tool 23 to the tool detection position P.

The detection unit 13 is implemented, for example, by the CPU operating. The detection unit 13 detects a signal indicating the tool detection position P, output by the pressing down of the measuring instrument 22. The detection unit 13 detects, for example, the output, from the measuring instrument 22, of a signal indicating that the tool detection position P has been reached, by further movement of the tip of the standard tool 23 in contact with the pressed surface U of a switch S. The detection unit 13 detects, for example, a signal output at a position to which the pressed surface U of the measuring instrument 22 is pressed down by a first predetermined distance, as a signal at the tool detection position P.

The identification unit 14 is implemented, for example, by the CPU operating. The identification unit 14 identifies the tool detection position P of the measuring instrument 22 based on the position of the tip of the standard tool 23 at the timing when the signal is detected. The identification unit 14 identifies, as the tool detection position P, a position to which the pressed surface U of the measuring instrument 22 is pressed down by a first predetermined distance. The identification unit 14 identifies, for example, the height (distance) from the reference position F to the tool detection position P based on the position obtained from the attachment position of the standard tool 23 and the known length of the standard tool 23 at the timing when the signal is detected.

Next, the operation flow of the measuring device 1 will be described. First, the speed acquisition unit 11 acquires a preset feed speed. Next, the movement control unit 12 moves the tip position of the standard tool 23 to a position above the measuring instrument 22. Next, the movement control unit 12 moves the tip of the standard tool 23 from the position above and at a predetermined distance from the measuring instrument 22, toward the measuring instrument 22 at the acquired feed speed. Next, the detection unit 13 receives a signal output when the tip of the standard tool 23 reaches the tool detection position P.

Next, the identification unit 14 identifies the coordinates of the tool detection position P from the tip position of the standard tool 23 at the timing when the signal is acquired. Thus, the operation of the measuring device 1 ends.

Next, the program of the present disclosure will be described. Each of the features included in the measuring device 1 can be implemented by hardware, software, or a combination thereof. Here, “implemented by software” means that it is implemented by a computer reading and executing a program.

The program may be stored and provided to the computer using various types of non-transitory computer readable media. The non-transitory computer readable media include various types of tangible storage media. Examples of the non-transitory computer readable media include magnetic recording media (e.g., flexible disks, magnetic tapes, hard disk drives), magneto-optical recording media (e.g., magneto-optical disks), CD-ROMs (read only memories), CD-Rs, CD-R/Ws, and semiconductor memories (e.g., mask ROMs, PROMs (programmable ROMs), EPROMs (erasable PROMs), flash ROMs, and RAMs (random access memories)). The program may also be provided to the computer by various types of transitory computer readable media. Examples of the transitory computer readable media include electrical signals, optical signals, and electromagnetic waves. The transitory computer readable media can provide the program to the computer via wired communication paths such as electric wires and optical fibers, or wireless communication paths.

As described above, according to the measuring device 1 and the program according to the first embodiment, the following effects are achieved.
(1) A measuring device 1 for measuring, with respect to a measuring instrument 22 for measuring a length of a cutting tool 21 attached to a machine tool 2, a distance from a reference position F of the machine tool 2 to a tool detection position P of the measuring instrument 22. The measuring device 1 includes a speed acquisition unit 11 configured to acquire a preset feed speed at which the cutting tool 21 is moved toward the measuring instrument 22 when the length of the cutting tool 21 is measured, a movement control unit 12 configured to move a tip of a standard tool 23 having a known length attached to the machine tool 2 toward the measuring instrument 22 at the feed speed acquired by the speed acquisition unit 11, thereby causing the standard tool 23 to press down a pressed surface U of the measuring instrument 22, a detection unit 13 configured to detect a signal indicating the tool detection position P, output by the pressing down of the measuring instrument 22, and an identification unit 14 configured to identify the tool detection position P of the measuring instrument 22 based on a position of the tip of the standard tool 23 at a timing when the signal is detected.

Thus, the output timing of the signal indicating when the tool detection position P is reached can be optimized depending on the feed speed of the cutting tool 21 set by the user of the machine tool 2 or the like. Therefore, even when the feed speed set by the user or the like is different at the time of measuring the tool length of the cutting tool 21 of the machine tool 2, the tool detection position P can be flexibly identified. Furthermore, the accuracy of identifying the tool detection position P can be improved.

### Second Embodiment

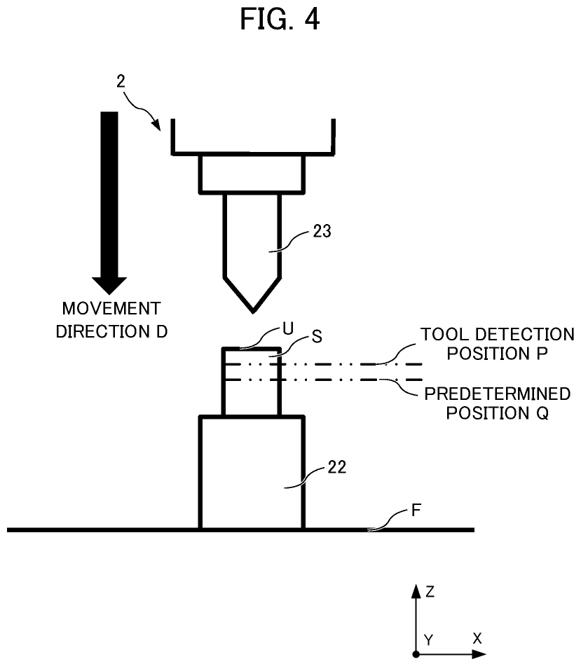

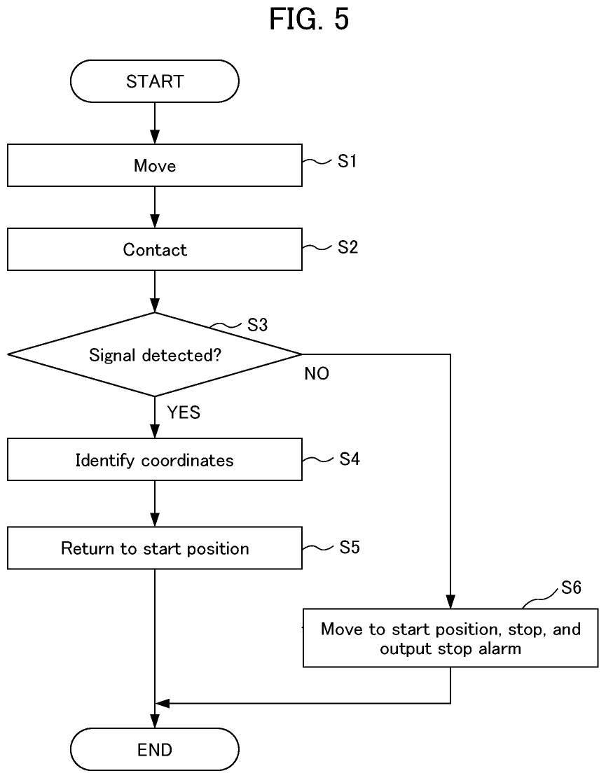

Next, a measuring device 1 and a program according to a second embodiment of the present disclosure will be described with reference to FIGS. 4 and 5. In the description of the second embodiment, the same components as those of the above embodiment are denoted by the same reference numerals, and descriptions thereof will be omitted or simplified. The measuring device 1 according to the second embodiment restricts the movement of a standard tool 23 when a signal is not output due to a disconnection or the like even though the tip of the standard tool 23 reaches a tool detection position P. This can protect the standard tool 23 and a measuring instrument 22.

The measuring device 1 of the second embodiment differs from that of the first embodiment in that a detection unit 13 detects the movement of the tip of the standard tool 23 to a predetermined position Q pressed down by a second predetermined distance from the tool detection position P. Furthermore, the measuring device 1 of the second embodiment differs from that of the first embodiment in that a movement control unit 12 stops the standard tool 23 based on the detection of the movement to the predetermined position Q.

For example, as shown in FIG. 4, the measuring instrument 22 is configured to be able to output a signal for stopping the standard tool 23 when detecting the movement of the standard tool 23 to the predetermined position Q pressed down by the second predetermined distance from the tool detection position P of the measuring instrument 22. The measuring instrument 22 includes, for example, a sensor (not shown) for detecting the movement of the standard tool 23 to the predetermined position Q.

Next, the operation of the measuring device 1 will be described with reference to the flowchart in FIG. 5. First, the movement control unit 12 moves the tip position of the standard tool 23 to a position above the measuring instrument 22 (Step S1). Next, the movement control unit 12 moves the tip of the standard tool 23 toward the measuring instrument 22 at a feed speed acquired from the measuring instrument 22 (Step S2).

Next, the detection unit 13 determines whether a signal output when the tip of the standard tool 23 reaches the tool detection position P is received (Step S3). In a case where the signal is received (Step S3: YES), the processing advances to Step S4. On the other hand, in a case where the signal is not received (Step S3: NO), the processing advances to Step S6.

In Step S4, the identification unit 14 identifies the position of the tool detection position P based on the received signal and the tip position of the standard tool 23. In Step S5, the movement control unit 12 returns the standard tool 23 to the start position. Thus, the processing of this flow ends.

In Step S6 (Step S3: NO), the movement control unit 12 moves the standard tool 23 to the start position, then stops it, and outputs a stop alarm. Thus, the processing of this flow ends.

As described above, according to the measuring device 1 and the program of the second embodiment, the following effects are achieved.
(2) The detection unit 13 detects the movement of the tip of the standard tool 23 to the predetermined position Q lower than the tool detection position P, and the movement control unit 12 stops the standard tool 23 based on the detection of the movement to the predetermined position Q. This can restrict the standard tool 23 from moving toward the measuring instrument 22 by a predetermined distance or more. Therefore, the standard tool 23 and the measuring instrument 22 can be protected.

Although preferred embodiments of the measuring device and the program of the present disclosure have been described above, the present disclosure is not limited to the above-described embodiments, and can be modified as appropriate. For example, in the above embodiments, the measuring device 1 may be configured as a part of a calibration device for calibrating the coordinates of the tool detection position P of the measuring instrument 22. Thus, when actually measuring the tool length of the cutting tool 21, it is possible to improve the accuracy of measuring the tool length.

Furthermore, in the second embodiment, the movement control unit 12 may start the movement of the standard tool 23 from a position located at a third predetermined distance from the measuring instrument 22, and may restrict the standard tool 23 from moving by a fourth predetermined distance or more. This can protect the measuring instrument 22 and the standard tool 23 even when signals detecting the tool detection position P and the predetermined position Q cannot be acquired.

### EXPLANATION OF REFERENCE NUMERALS

1 measuring device
2 machine tool
11 speed acquisition unit
12 movement control unit
13 detection unit
14 identification unit
21 cutting tool
22 measuring instrument
23 standard tool
32 table
F reference position
P tool detection position
Q predetermined position
U pressed surface

1. A measuring device for measuring, with respect to a measuring instrument for measuring a length of a cutting tool attached to a machine tool, a distance from a reference position of the machine tool to a tool detection position of the measuring instrument, the measuring device comprising:
a speed acquisition unit configured to acquire a preset feed speed at which the cutting tool is moved toward the measuring instrument when the length of the cutting tool is measured;
a movement control unit configured to move a tip of a standard tool having a known length attached to the machine tool toward the measuring instrument at the feed speed acquired by the speed acquisition unit, thereby causing the standard tool to press down a pressed surface of the measuring instrument;
a detection unit configured to detect a signal indicating the tool detection position, output by the pressing down of the measuring instrument; and
an identification unit configured to identify the tool detection position of the measuring instrument based on a position of the tip of the standard tool at a timing when the signal is detected.

2. The measuring device according to claim 1, wherein the identification unit is configured to identify, as the tool detection position, a position to which the pressed surface of the measuring instrument is pressed down by a first predetermined distance.

3. The measuring device according to claim 1,
wherein the detection unit is configured to detect a signal for stopping the standard tool, output by pressing down from the tool detection position by a second predetermined distance, and
wherein the movement control unit is configured to stop the movement of the standard tool based on the detection of the signal for stopping the standard tool.

4. The measuring device according to claim 3, wherein the movement control unit is configured to start the movement of the standard tool from a position located at a third predetermined distance from the pressed surface of the measuring instrument and to restrict the standard tool from moving by a fourth predetermined distance or more.

5. A non-transitory computer readable media which non-transitorily stores a program causing a computer to function as a measuring device for measuring, with respect to a measuring instrument for measuring a length of a cutting tool attached to a machine tool, a distance from a reference position of the machine tool to a tool detection position of the measuring instrument,
the program causing the computer to function as:
a speed acquisition unit configured to acquire a preset feed speed at which the cutting tool is moved toward the measuring instrument when the length of the cutting tool is measured;
a movement control unit configured to move a tip of a standard tool having a known length attached to the machine tool in an axial direction at the acquired feed speed, thereby causing the standard tool to press down a pressed surface of the measuring instrument;
a detection unit configured to detect a signal indicating the tool detection position, output by the pressing down of the measuring instrument; and
an identification unit configured to identify the tool detection position of the measuring instrument based on a position of the tip of the standard tool at a timing when the signal is detected.
